(19) United States
(12) Patent Application Publication
(10) Pub. No.: US 2019/0178159 A1
(43) Pub. Date: Jun. 13, 2019

(54) MULTISTAGE RADIAL COMPRESSOR AND TURBINE

(71) Applicant: In2rbo, Inc., Sunnyvale, CA (US)

(72) Inventors: Alexey Shipachev, Sunnyvale, CA (US); Alexey Veretelnik, Sunnyvale, CA (US); Alexey Petrosyan, Sunnyvale, CA (US)

(73) Assignee: In2rbo, Inc., Sunnyvale, CA (US)

(21) Appl. No.: 16/323,440

(22) PCT Filed: Aug. 9, 2017
(86) PCT No.: PCT/US17/46047

§ 371 Date: Feb. 5, 2019

Related U.S. Application Data
(60) Provisional application No. 62/372,998, filed on Aug. 10, 2016.

(51) Int. Cl. F02C 3/06; F04D 19/02; F04D 29/52

(52) U.S. Cl. CPC F02C 3/06; F04D 29/522; F04D 19/02

(57) ABSTRACT

A multistage radial microturbine device comprising at least three compressor stages and at least three turbine stages.

This patent application claims the benefit of the Aug. 10, 2016 filing date of the U.S. provisional application No. 62/372,998.

### FIELD OF THE INVENTION

The present invention is related generally to the field of heat engines designed to convert the heat energy into mechanical energy of rotation, More particularly, the present invention is related to the field of small gas turbine engines also known as microturbines.

### BACKGROUND OF THE INVENTION

Gas turbine devices such as microturbine engines are known to be used to convert the thermal energy released by fuel combustion into mechanical energy of a rotating shaft. A microturbine engine typically comprises a single stage radial compressor and a single stage radial turbine attached to a common shaft. The compressed air flows from the compressor into the combustion chamber where it mixes with the fuel that burns releasing the thermal energy and increasing the gas temperature. The hot gas energy is then converted into the rotation energy of the single stage radial turbine as described in U.S. Pat. No. 6,748,742, incorporated herein by reference. Herein “radial” means the gas enters the compressor or the turbine in the direction primarily parallel to the rotating shaft and then is expelled by the rotating disk in the primarily radial direction, or the direction primarily perpendicular to the rotating shaft. Herein “Single stage” means the compressor comprises only one rotating disc and the turbine comprises only one rotating disk; “multistage” means the compressor comprises at least three rotating disks and the turbine comprises at least three rotating disks.

It is a common practice to have a single stage compressor and a single stage turbine positioned on the same rotating shaft which transfers a part of the energy from the turbine to power the compressor. In addition, the residual energy of the hot exhaust from the turbine is directed to a recuperator or a heat exchanger used to heat the compressed air entering the combustion chamber.

The efficiency of the turbine engine is the ratio of useful mechanical energy of the rotating shaft to the total thermal energy released by combusting fuel. The efficiency increases with the greater compression ratio that increases the amount of energy transferred to the turbine while the hot gas expands. The compression ratio of the compressor is limited by the rotating speed of the compressor disc and by the mechanical strength of the disc material, therefore, a one stage compressor is not sufficient to supply the compression ratio required for increased efficiency and the use of additional devices is required to capture the remaining heat energy and to return this energy into the thermal engine cycle.

Another important factor affecting the efficiency is the amount of thermal energy that the turbine can extract from the hot expanding gas. If the temperature of the gas entering the turbine is constant, the efficiency will be the greatest for the lowest gas temperature exiting the turbine. A single stage turbine does not effectively extract thermal energy from the hot gas, resulting in high temperature of the exiting gases and overall lower efficiency.

To compensate for the low efficiency of single stage compressor and single stage turbine engines, a heat exchanger or recuperator is used to utilize the thermal energy of exiting gases from the turbine to heat the compressed air entering the combustion chamber. Addition of the recuperator increases the cost and the weight of the engine while also reducing the device reliability, and increases the cost of maintenance because the recuperator is contaminated by the combustion products. The use of the recuperator also limits single stage turbines primarily to stationary applications as the application for vehicle, vessel, and aircraft propulsion is problematic due to large size, increased weight, and poor reliability.

A gas turbine engine with a 2-stage helical flow radial compressor is also known from U.S. Pat. No. 6,709,243, incorporated herein by reference. However, 2-stage helical flow radial compressors can suffer low efficiency and reduced reliability due to the overheating.

### SUMMARY OF THE INVENTION

The present invention addresses the problems described in the background section. It is an aim of this invention to greatly increase the efficiency of a radial turbine engine.

The present invention achieves the increased efficiency in a turbine engine comprising a multistage radial compressor and a multistage radial turbine where “multistage” means the number of stages in the compressor is at least 3 (three) and the number of stages in the turbine is at least 3 (three).

The present invention provides for a higher compression ratio of the air entering the combustion chamber by utilizing a multistage radial compressor wherein the air entering each stage after the first, air entry stage of the compressor is further compressing the air supplied by the previous stage. The present invention provides for a lower exhaust temperature wherein each consecutive radial turbine stage after the first turbine stage adjacent the combustion chamber further reduces the temperature of the gas exhausted by the previous stage.

The present invention provides the method to reduce the cost of manufacturing the working disks of the compressor and turbine by using Powder Injection Molding and Metal Injection Molding methods to fabricate the said parts.

The present invention achieves high efficiency without the use of expensive, heavy, and unreliable recuperators.

Further, the present invention utilizes compressor guide vanes that are movable with the respect of the rotating compressor discs to compensate for thermal expansion and stress elongation of the shaft.

### BRIEF DESCRIPTION OF THE DRAWINGS

The present invention is illustratively shown and described in reference to the accompanying drawings, in which

FIG. 1 is a front view of the microturbine engine.

FIG. 2 is a side view of the microturbine engine.

FIG. 3 shows an axial section of the microturbine engine.

FIG. 4 is a magnified section view of the compressor.

FIG. 5 is a magnified section view of the turbine.

FIG. 6 shows a further magnified section view of the first and second stages of the compressor.

FIG. 7 shows an even further magnified section view of a guide vane of the compressor.

FIG. 8 shows the thrust unit.

FIG. 9 shows the position of the guide vane when the turbine is not operational.

FIG. 10 shows the position of the guide vane when the turbine is operational.

FIGS. 11 and 11a show an axial section of the engine at the first turbine stage.

### DETAIL DESCRIPTIONS OF THE INVENTION

All descriptions are for the purpose of showing selected versions of the present invention and are not intended to limit the scope of the present invention.

The present invention resolves the problems described in the previous sections. The present invention achieves greater efficiency, lower cost and improved reliability of a turbine generator by implementing a multi-stage compressor and a multi stage turbine with the individual stages fabricated utilizing machining, powder injection molding, (PIM) and metal injection molding (MIM) technology.

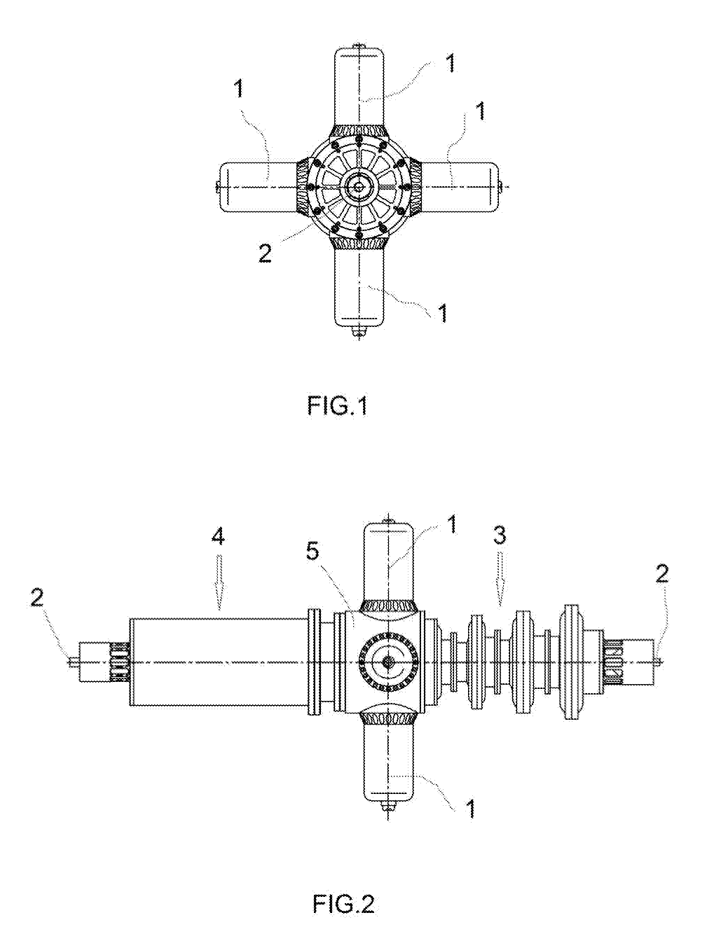

The apparatus of the present invention, shown in FIG. 1 (front view) and FIG. 2 (side view), comprises a combustion chamber 1, a rotating shaft 2, a multistage turbine 3, and a multistage compressor 4. The combustion chamber 1, the multistage turbine 3 and the multistage compressor 4 are all attached to the same shaft 2, and are all contained in a main housing 5. What is meant by a multistage turbine 3 is a turbine that has multiple stages where each stage is comprised of a turbine disk that rotates with the shaft 2 and a turbine guide vane that surrounds the turbine disk and does not rotate. What is meant by a multistage compressor 4 is a compressor that has multiple stages where each stage is comprised of a compressor disk that rotates with the shaft 2 and a compressor guide vane that surrounds the compressor disk and does not rotate. Multistage Turbine implementation shown in FIGS. 1-3 has five compressor stages and five turbine stages, however, multistage implementations may have the number of stages greater than five or fewer than five and equal or greater than three. Also, in a multistage implementation, the number of stages in the compressor may be different from the number of stages in the turbine as long as the smallest of the two numbers is equal or greater than three. The operation of the apparatus of the present invention is achieved by combusting the fuel in the combustion chamber 1 and directing hot gases of combustion from the combustion chamber and into the multistage turbine 3. The hot expanding gas exiting the combustion chamber 1 causes the turning of the multiple turbine stages of the multistage turbine 3 and converting the thermal energy into the mechanical energy of the rotating shaft 2. Part of the mechanical energy is passed through the shaft 2 to the multistage compressor 4 which compresses the air and directs the compressed air into the combustion chamber 1 which mixes the compressed air with fuel and combusts the fuel. The hot exhaust gas from the combusted fuel is then directed into the multistage turbine 3. Electrical generation can be achieved by connecting a generator (not shown) to the shaft 2.

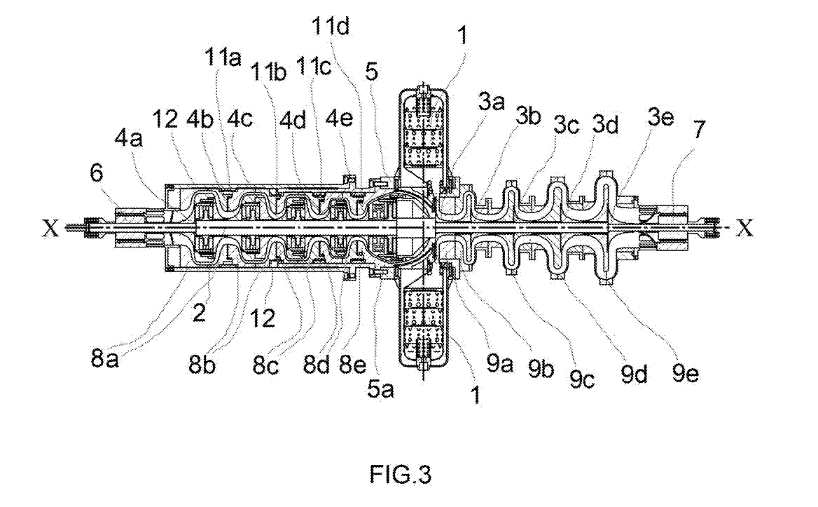

The side section of the apparatus of present invention is shown in FIG. 3. With the reference to FIG. 3 the multistage compressor 4 has five compressor stages with five rotating compressor disk stages 4a, 4b, 4c, 4d, and 4e secured stationary on the shaft 2. The multistage turbine 3 has five turbine stages with five rotating turbine disk stages 3a, 3b, 3c, 3d, and 3e secured stationary on the same shaft 2. The shaft 2 has a bearing 6 located on the left end of the shaft 2 as viewed in FIG. 3 where air enters the multistage compressor 4, and another bearing 7 located on the right side of the shaft 2 as viewed in FIG. 3 where exhaust gases exit the multistage turbine 3. The bearings 6 and 7 are of the journal kind to sustain the radial forces and prevent radial movement of the shaft 2, and to allow axial movement of the shaft 2 along the shaft 2 axis x-x of rotation due to the thrust forces and shaft elongation at increased temperature and rotation speed. The main housing 5, located between the multistage turbine 3 and the multistage compressor 4, has a thrust journal bearing 5a that can sustain both radial and axial forces. The combustion chamber 1 is attached to the main housing 5. Each rotating compressor disk of the compressor stages 4a, 4b, 4c, 4d, and 4e has an associated non-rotating compressor guide vane 8a, 8b, 8c, 8d, and 8e, respectfully. Each rotating turbine disk of the turbine stages 3a, 3b, 3c, 3d, and 3e has an associated non-rotating turbine guide vane 9a, 9b, 9c, 9d, and 9e, respectively.

With the further reference to FIG. 3, each rotating compressor disk 4a, 4b, 4c, 4d, 4e and its associated non-rotating compressor guide vane 8a, 8b, 8c, 8d, 8e comprises a working stage of the multi-stage compressor 4 and each rotating turbine disk 3a, 3b, 3c, 3d, 3e and its associated non-rotating turbine guide vane 9a, 9b, 9c, 9d, 9e comprises a working stage of the multistage turbine 3. The first four stages of the multistage compressor 4 have compressor guide vanes 8a, 8b, 8c, 8d that are moveable in the axial direction from right to left as viewed in FIG. 3 in response to increasing pressure in the multistage compressor 4 produced by rotation of the shaft 2 and the rotation of the compressor disks 4a, 4b, 4c, 4d, 4e on the shaft 2. This enables the compressor guide vanes 8a, 8b, 8c, 8d to move axially from right to left as viewed in FIG. 3 to compensate for movement of the respective compressor disks 4a, 4b, 4c, 4d from right to left due to axial elongation of the shaft 2 caused by the increasing temperature of the shaft and axial forces applied to the shaft during operation of the turbine. To form a pressure seal, the first moveable compressor guide vane 8a has an annular seal 11a around the interior of a cylindrical portion of the guide vane on a downstream end of the first guide vane 8a from the air intake of the multistage compressor 4. The annular seal 11a extends around an annular groove in the second compressor guide vane 8b and provides a pressure seal between the first compressor guide vane 8a and the second compressor guide vane 8b. The second compressor guide vane 8b has two similar annular seals 11a and 11b on opposite sides of the second compressor guide vane. The third compressor guide vane 8c has two similar annular seals 11b and 11c on opposite sides of the third compressor guide vane. The fourth compressor guide vane 8d has two similar annular seals 11c and 11d on opposite sides of the fourth compressor guide vane. The fifth compressor guide vane 8e has the annular seal 11d in an annular groove on the upstream end of the fifth compressor guide vane toward the air intake of the multistage compressor 4. The annular seals 11a, 11b, and 11c are also movable in the axial direction of the rotating shaft. For example, the annular seal 11a moves axially with the compressor guide vane 8b, the annular seal 11b moves axially with the compressor guide vane 8c and the annular seal 11c moves axially with the compressor guide vane 8d. Each of the annular seals 11a, 11b, 11c, 11d has a different diameter to compensate for the increasing pressure difference between the input and output sides of each of the compressor disks 4a, 4b, 4c, 4d with the diameter increasing from left to right as viewed in FIG. 3 with the increasing pressure. The movable compressor guide vanes 8a, 8b, 8c, 8d, and 8e each have axial keys that fit into and move along the keyways or guide channels 12 and 12a that are attached to the main housing 5. The guide channels 12 and 12a are spatially arranged around the interior surface of the main housing and allow the compressor guide vanes 8a, 8b, 8c, 8d to move axially through the main housing 5 while preventing their rotation.

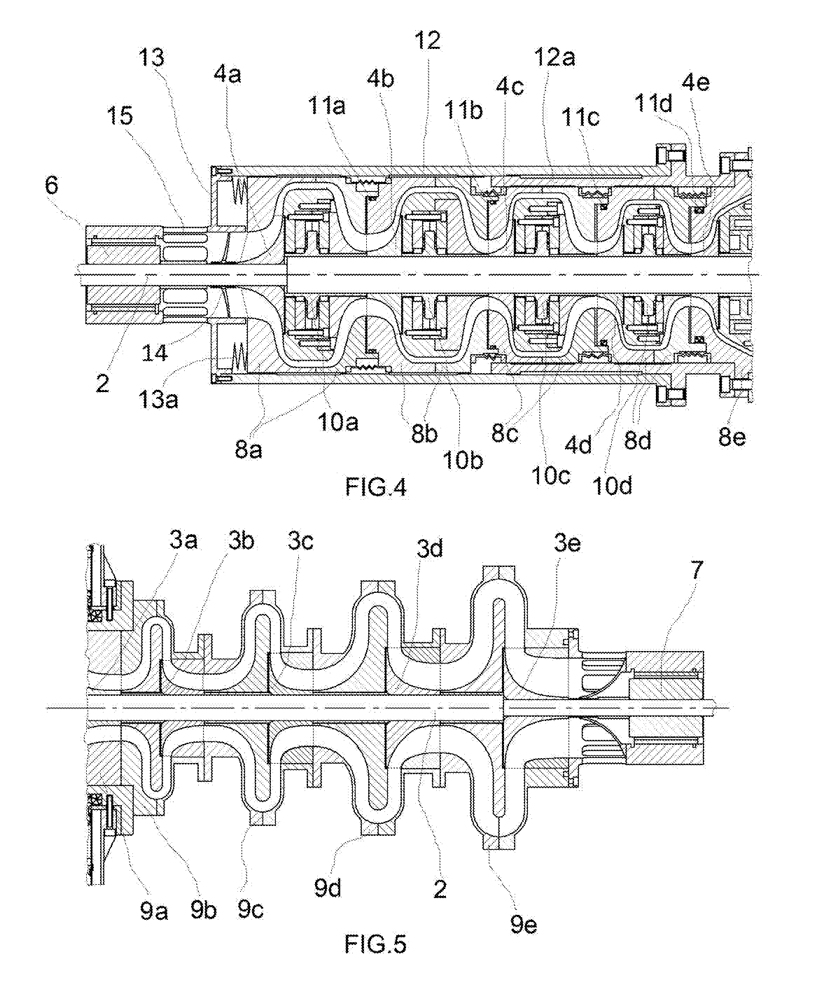

A more detailed side section view of the multistage compressor 4 is shown in FIG. 4. To provide registration of movable compressor guide vanes 8a, 8b, 8c, 8d, and 8e when rotating compressor disks 4a, 4b, 4c, 4d, and 4e move in the axial direction with elongation of the loaded shaft 2, each compressor disk 4a, 4b, 4c, 4d and 4e has a bi-directional thrust bearing 10a, 10b, 10c, 10d, and 10e, respectively. The compressor guide vane 8a in the first stage of the multistage compressor 4 has a radial seal 11a that joins it to the next stage compressor guide vane 8b. The compressor disk 4a in the first stage of the multistage compressor 4 has a two-sided thrust bearing 10a that provides precise axial registration with the respect of compressor disk 4a as the shaft 2 elongates. The opposite side of the first guide vane 8a has an elastic thrust element 13a with the stiffness designed and calibrated to compensate the difference of input and output pressure on the guide vane and taking into account the section area of annular seal 11a. The elastic element 13a could be a single spring assembly that extends around the shaft 2 and biases the first compressor guide vane 8a to the right as viewed in FIG. 4, or could be multiple spring assemblies arranged around the shaft 2. On the other side the elastic element 13a is set against the housing 13. Housing 13 has a nozzle assembly 14 of the first stage compressor disk 4a, air intake 15, and front journal bearing 6. The housing 13 is connected to the guide channel 12.

A more detailed side section of the multistage turbine 3 is shown in FIG. 5. The expanding gas sequentially passes the turbine stages comprising the rotating disks 3a, 3b, 3c, 3d, and 3e and stationary guide vanes 9a, 9b, 9c, 9d, and 9e. The radial positioning of the shaft 2 is achieved by journal bearing 7 at the exhaust of the turbine. The position of the rotating turbine disks with the respect of the turbine guide vanes does not affect the turbine efficiency as much as the position of the compressor guide vanes. Therefore, the axial position of the turbine guide vanes is fixed and the turbine guide vanes are not movable in any direction.

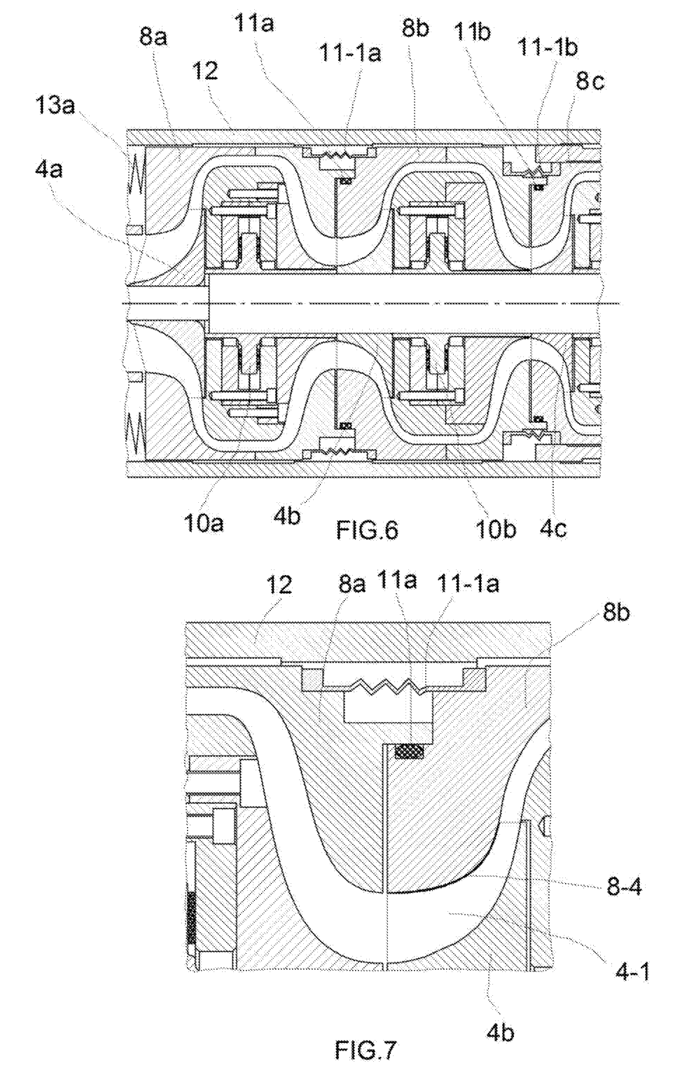

FIG. 6 shows further details of first two compressor stages comprising rotating disks 4a, 4b and guide vanes 8a, 8b.

FIG. 7 shows even further details of the position of two compressor guide vanes 8a and 8b including a movable annular seal 11a and a flexible spring bellows seal 11-1a. The movable annular seal 11a and the flexible spring bellows seal 11-1a extend completely around the first compressor guide vane 8a and the second compressor guide vane 8b to seal a required working gap 4-1 that must be maintained between the rotating compressor disk 4b and the compressor guide vane 8b as the shaft is expanding and elongating under the temperature and thrust load. Here 4-1 is the gap formed between the working disk surface of the compressor disk 4b and the compressor guide vane 8b. This working gap requirement applies to all 5 stages of the compressor and is critical for optimizing the compressor efficiency. The choice of material for the compressor seals depends on the stage number as the operating temperature increases with the stage number.

The multistage compressor and turbine engine requires a shaft much longer than the shaft used for a single stage turbine. The shaft elongates during the turbine operation due to the axial loads at elevated temperatures with a longer shaft in the multistage engine having greater absolute elongation than a shorter shaft in a single stage engine. Therefore, a multistage compressor requires an additional element to compensate for shaft elongation during the engine operation.

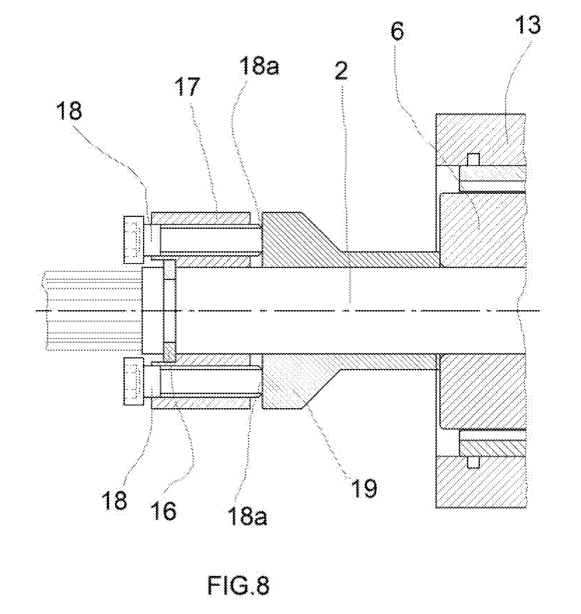

FIG. 8 shows the pre-tension module positioned on the shaft 2 that comprises the thrust ring 16, truss bushing 17, and adjustment screws 18 having threaded connection to the bushing 17, and having the ends 18a set against the compensating thrust bushing 19. Compensating bushing 19, together with calibrated torque of adjustment screws 18 compensates for the elongation and stress of the engine shaft 2. The compensating bushing 19 is constructed of a resilient material. Prior to operation of the apparatus, the adjustment screws are screw threaded into the truss bushing, from left to right as viewed in FIG. 8. This causes the ends 18a of the adjustment screws 18 to compress the compensating bushing 19. On operation of the apparatus, the temperature of the shaft increases and the shaft 2 elongates. The elongation of the shaft 2 relieves the compression load on the compensating bushing allowing the compensating bushing 19 to expand. The expanding compensating bushing remains in contact with the ends 18a of the adjustment screws 18 and the bearing 6, maintaining the positioning of the bearing 6 in the apparatus. The calibrated torque depends on the thermal and mechanical properties of the materials used in the compressor and turbine and is set during the engine assembly.

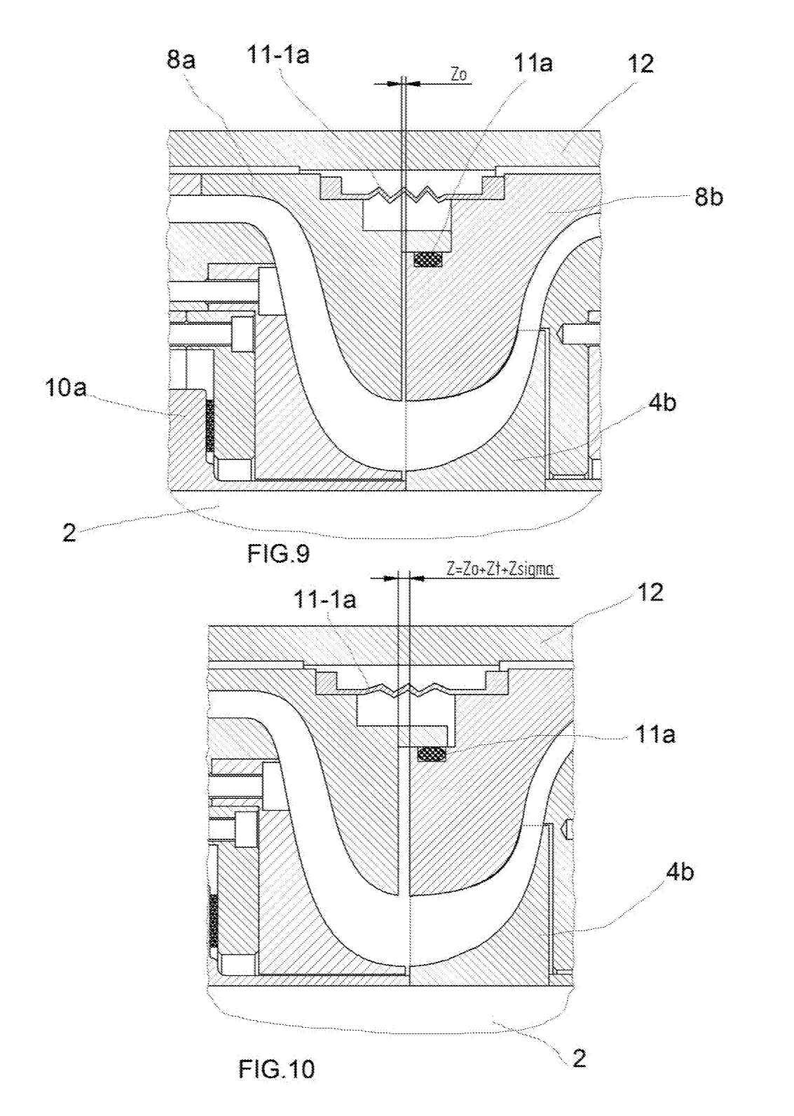

FIG. 9 and FIG. 10 show the position of the guide vanes 8a and 8b next to each other and movable along the shaft. FIG. 9 shows the position of the guide vanes when the turbine is stopped while FIG. 10 shows the position of the guide vanes when the turbine is operational. When the turbine is operating the working gap increases from Zo to Zo+Zt+Zsigma due to the shaft elongation under the axial load at increased temperature. The entire stack of movable guide vanes is spring-loaded by the elastic element 13a shown in FIG. 4 that returns the reduces Zsigma distance as the operating speed of the engine is reduced and returns the guide vanes in the original position in FIG. 9 when the engine is stopped.

FIGS. 3 and 4 show the positions of the compressor disks 4a, 4b, 4c, 4d, 4e and their respective compressor guide vanes 8a, 8b, 8c, 8d and 8e in the main housing 5 prior to combustion taking place in the combustion chamber 1. As combustion is initiated in the combustion chamber 1, the shaft 2 begins to rotate and begins to increase in temperature. As the temperature of the shaft 2 increases, the shaft 2 begins to elongate from right to left as viewed in FIGS. 3 and 4. As the shaft 2 begins to elongate from right to left, the compressor disks 4a, 4b, 4c, 4d, 4e secured on the shaft 2 begin to move from right to left.

As the shaft 2 in the multistage compressor 4 rotate the compressor disks 4a, 4b, 4c, 4d, 4e, the compressor disks pull air into the multistage compressor 4 through the nozzle assembly 14 and the air intake 15. The rotating compressor disks 4a, 4b, 4c, 4d, 4e push the air from left to right as viewed in FIGS. 3 and 4. As the air flows through the multistage compressor 4 from left to right, the rotating compressor disks 4a, 4b, 4c, 4d, 4e increase the pressure of the air flowing through the multistage compressor 4. The increasing air pressure increases in each successive stage of the multistage compressor 4 as the air moves through the compressor from left to right. For example, the air traveling through the first stage by the rotation of the first compressor disk 4a will be at a first pressure. The air traveling through the second stage by rotation of the second compressor disk 4b will be at a second pressure that is greater than the first pressure. The air traveling through the third compressor stage by the rotation of the third disk 4c will have a third pressure that is greater than the second pressure. The air traveling through the fourth stage of the multistage compressor 4 by the rotation of the fourth compressor disk 4d will be at a fourth pressure greater than the third pressure. The air traveling through the fifth stage of the multistage compressor 4 by the rotation of the fifth compressor disk 4e will be at a fifth pressure that is greater than the fourth pressure.

The increasing air pressure in each stage of the multistage compressor 4 acts on the compressor guide vane in that stage and moves the guide vane to a position in the main housing 5 where the guide vane is substantially centered relative to the compressor disk rotating in that stage. For example, rotation of the compressor disk 4a in the first stage of the multistage compressor 4 increases the air pressure in that stage and the increasing air pressure causes the compressor guide vane 8a to move from right to left slightly where the compressor guide vane 8a is substantially centered relative to the rotating compressor disk 4a. The rotating compressor disk 4b in the second stage of the multistage compressor 4 increases the air pressure in the second stage which acts on the compressor guide vane 8b of the second stage and causes the compressor guide vane 8b to move slightly from right to left to a substantially centered position of the compressor guide vane 8b relative to the compressor disk 4b. Rotation of the compressor disk 4c in the third stage of the multistage compressor 4 increases the air pressure in the third stage which acts on the compressor guide vane 8c in the third stage and causes the compressor guide vane 8c to move from right to left slightly to a position where the compressor guide vane 8c is substantially centered relative to the compressor disk 4c. The rotation of the compressor disk 4d in the fourth stage of the multistage compressor 4 increases the air pressure in the fourth stage which acts on the fourth compressor guide vane 8d moving the fourth compressor guide vane 8d from right to left slightly where the fourth compressor guide vane 8d is substantially centered relative to the fourth compressor disk 4d. The rotation of the fifth compressor disk 4e in the fifth stage of the multistage compressor 4 increases the air pressure in the fifth stage which acts on the fifth compressor guide vane 8e in the fifth stage which moves the compressor guide vane 8e from right to left slightly where the fifth compressor guide vane 8e is substantially centered relative to the fifth compressor disk 4e.

The movement of the compressor guide vanes 8a, 8b, 8c, 8d, 8e from right to left as viewed in FIGS. 3 and 4 is resisted by the compression of the elastic thrust element 13a.

When combustion in the combustion chamber 1 is halted, the rotation of the shaft 2 slows and the shaft is eventually stopped. The pressure in the multistage compressor 4 by the rotation of the compressor disk 4a, 4b, 4c, 4d, 4e is relieved. The shaft 2 begins to cool and contract from right to left as viewed in FIGS. 3 and 4. The cooling shaft 2 moves the compressor disk 4a, 4b, 4c, 4d, 4e from left to right as viewed in FIGS. 3 and 4 as the shaft cools. With the pressure relieved in the multistage compressor 4, the elastic thrust element 13a pushes the compressor guide vanes 8a, 8b, 8c, 8d, 8e from left to right as viewed in FIGS. 3 and 4, to substantially centered positions of the compressor guide vanes 8a, 8b, 8c, 8d, 8e relative to their respective compressor disks 4a, 4b, 4c, 4d, 4e.

The combination of pre-tensioned shaft, movable guide vanes and elastic elements compensates for the shaft elongation and improves the efficiency of compressor operation at different speeds and while starting from the complete stopped position.

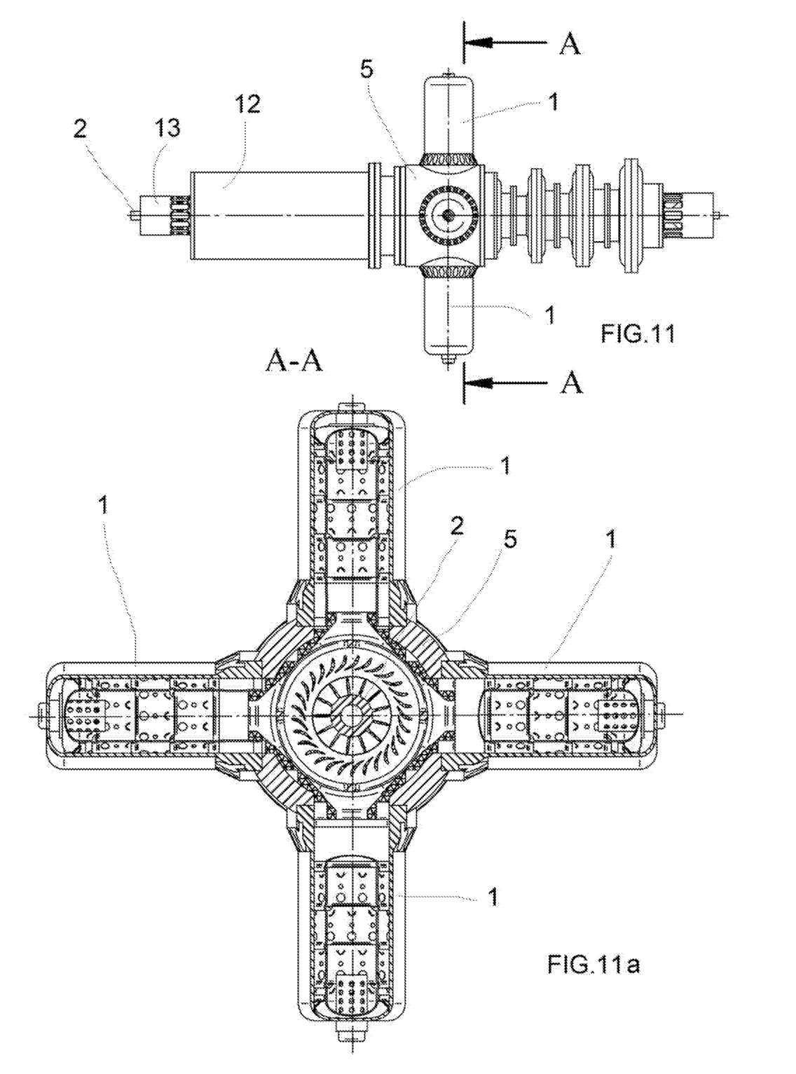

FIG. 11 is the engine section along the direction 11a at the first turbine stage showing four combustion chambers 1 positioned perpendicular to the shaft 2 and utilizing gaseous or liquid fuel.

This invention is not limited to the embodiment described and can be implemented by one skilled in the art with some modifications and alterations within the spirit and scope of the embodiment as disclosed.

What is claimed is:

1. A gas turbine device that converts energy of fuel combustion into mechanical energy, the gas turbine device comprising:
a multistage compressor, the multistage compressor having at least three compressor stages; and,
a multistage turbine, the multistage turbine having at least three turbine stages.

2. The gas turbine device of claim 1, further comprising:
the multistage compressor and the multistage turbine being on a same, single shaft.

3. The gas turbine device of claim 1, further comprising:
the multistage compressor has a first number of compressor stages;
the multistage turbine has a second number of turbine stages; and,
the first number and the second number differ by no more than one.

4. The gas turbine device of claim 2, further comprising:
the multistage compressor having a plurality of compressor disks on the shaft;
each compressor stage of the multistage compressor having a compressor disk of the plurality of compressor disks on the shaft; and,
the compressor disks are tightened along the shaft by a pre-tension module.

5. The gas turbine device of claim 2, further comprising:
the multistage turbine having a plurality of turbine disks on the shaft;
each turbine stage of the multistage turbine having a turbine disk of the plurality of turbine disks on the shaft; and,
the plurality of turbine disks are tightened along the shaft by a pre-tension module.

6. The gas turbine device of claim 2, further comprising:
the multistage compressor having a plurality of compressor disks on the shaft and a plurality of compressor guide vanes in the multistage compressor, each compressor guide vane of the plurality of compressor guide vanes extending around a compressor disk of the plurality of compressor disks; and,
at least one compressor guide vane is adjustable in position along the shaft.

7. The gas turbine device of claim 4, further comprising:
the plurality of compressor disks are pre-tensioned along the shaft with the use of a pre-tension module comprising adjustment screws located outside a rotation axis of the shaft and that can be tightened independent from rotation of the shaft and a compensating bushing that expands as the shaft elongates during operation.

8. The gas turbine device of claim 1, further comprising:
at least one disc in the multistage compressor is manufactured using Metal Injection Molding method

9. The gas turbine device of claim 1, further comprising:
at least one disc in the multistage turbine is manufactured using Powder Injection Molding and Metal Injection Molding method.

10. The gas turbine device of claim 6, further comprising:
annular seals between compressor guide vanes where an input side and an output side seals on a same guide vane have a different diameter.

11. The gas turbine device of claim 10, further comprising:
a guide vane of a first stage is coupled to a housing of the multistage compressor by an elastic element.

12. The compressor device of claim 6, further comprising:
the plurality of compressor disks being secured on the shaft against movement of the compressor disks relative to the shaft.

13. The gas turbine device of claim 6, further comprising:
the at least one compressor guide vane is moveable in position along the shaft in response to increasing fluid pressure in the multistage compressor.

14. The gas turbine device of claim 6, further comprising:
the at least one compressor guide vane is one of a plurality of compressor guide vanes that are moveable in position along the shaft.

15. The gas turbine device of claim 6, further comprising:
an elastic element operatively connected to the at least one compressor guide vane, the elastic element being operable to resist movement of the at least one compressor guide vane along the shaft.

16. A gas turbine device that converts energy of fuel combustion into mechanical energy, the gas turbine device comprising:
a main housing;
a shaft mounted for rotation in the main housing;
a multistage compressor in the main housing, the multistage compressor having a plurality of compressor disks mounted on the shaft; and,
a multistage turbine in the main housing, the multistage turbine having a plurality of turbine disks mounted on the shaft.

17. The gas turbine device of claim 16, further comprising:
a combustion chamber in the main housing, the combustion chamber being mounted on the shaft between the multistage compressor and the multistage turbine.

18. The gas turbine device of claim 16, further comprising:
the multistage compressor having a plurality of compressor guide vanes in the main housing, each compressor guide vane of the plurality of compressor guide vanes being moveable along the shaft.

19. The gas turbine device of claim 16, further comprising:
the multistage compressor having a plurality of compressor disks on the shaft and a plurality of compressor guide vanes in the multistage compressor, each compressor guide vane of the plurality of compressor guide vanes extending around a compressor disk of the plurality of compressor disks; and,
at least one compressor guide vane is moveable in the main housing along the shaft.

20. The gas turbine device of claim 19, further comprising:
the at least one compressor guide vane is one of a plurality of compressor guide vanes that are moveable in the main housing along the shaft.
